(19) United States
(12) Patent Application Publication
(10) Pub. No.: US 2016/0136890 A1
(43) Pub. Date: May 19, 2016

(54) SYSTEM FOR THREE-DIMENSIONAL PRINTING BY SELECTIVE SINTERING

(71) Applicants: Diego CASTANON, Burnaby (CA); Jeff SNIDER, Langley (CA)

(72) Inventors: Diego Castanon, Burnaby (CA); Jeff Snider, Langley (CA)

(21) Appl. No.: 14/891,957

(22) PCT Filed: May 20, 2014
(86) PCT No.: PCT/CA2014/050464

§ 371 Date: Nov. 17, 2015

Related U.S. Application Data
(60) Provisional application No. 61/825,479, filed on May 20, 2013.
(60) Provisional application No. 61/824,927, filed on May 17, 2013.

(51) Int. Cl. B29C 67/00

(52) U.S. Cl. CPC B29C 67/0077; B29C 67/0085; B33Y 30/00

(57) ABSTRACT

A system for three-dimensional printing by selective sintering comprises a first laser, a second laser, and a tank disposed between the first laser and the second laser. The system may further include hoppers in communication with the tank. The first laser, the second laser, and the tank may be aligned either horizontally or vertically.

### BACKGROUND OF THE INVENTION

1. Field of the Invention

The present invention relates to a system for three-dimensional printing by selective sintering and, in particular, to a system for three-dimensional printing by selective sintering with two lasers.

2. Description of the Related Art

Conventional systems for three-dimensional printing by selective sintering generally comprise a tank configured to receive a material to be sintered, a dispenser for dispensing the material into the tank, and a laser for emitting a laser beam to selectively sinter the material in the tank. In operation, the dispenser dispenses a first layer of material into the tank and the laser emits a laser beam to selectively sinter the material in the tank to form a first cross-sectional layer of a three-dimensional object being formed.

The dispenser then dispenses a second layer of material into the tank and the laser emits a laser beam to form a second cross-sectional layer of the object being formed. The system accordingly forms successive adjacent cross-sections of the three-dimensional object step-wise in a vertical direction.

U.S. Pat. No. 4,863,538 which issued on Mar. 11, 1986 to Deckard, and the full disclosure of which is incorporated herein by reference, discloses a method and apparatus for selectively sintering a layer of powder to produce an object comprising a plurality of sintered layers. The apparatus includes a computer controlling a laser to direct the laser energy onto the powder to produce a sintered mass. The computer either determines or is programmed with the boundaries of the desired cross-sectional regions of the object. For each cross-section, the aim of the laser beam is scanned over a layer of powder and the laser beam is switched on to sinter only the powder within the boundaries of the cross-section. Powder is applied and successive layers sintered until a completed object is formed. The powder can comprise either plastic, metal, ceramic, or polymer substance. In the preferred embodiment, the aim of the laser is directed in a continuous raster scan and the laser turned on when the beam is aimed with the boundaries of the particular cross-section being formed.

### SUMMARY OF THE INVENTION

It is an objective of the present invention to provide an improved system for three-dimensional printing by selective sintering.

There is accordingly provided a selective sintering system comprising a first laser, a second laser, and a tank disposed between the first laser and the second laser. The selective sintering system may further include a dispenser in communication with the tank. The first laser, the second laser, and the tank may be aligned either horizontally or vertically.

An embodiment of the selective sintering system comprises a first laser, a second laser, and a tank disposed between the first laser and the second laser. The tank includes a first moveable partition and a second moveable partition which define a central chamber of the tank. A dispenser is in communication with and provides material to be sintered to the central chamber of the tank. The first moveable partition and the second moveable partition may each be moveable step-wise from innermost positions to outermost positions.

The first moveable partition may be moveable step-wise in tandem with the first laser. The second moveable partition may be moveable step-wise in tandem with the second laser. The first moveable partition may alternatively remain stationary and the second moveable partition may be moveable step-wise from an innermost position to an outermost position.

The first moveable partition and the second moveable partition may each be provided with a fillet at an upper edge thereof. The first moveable partition and the second moveable partition may each be provided with an angular extending flange at an upper edge thereof. The first moveable partition and the second moveable partition may each be provided with a bevel at an upper edge thereof. The first partition and the second partition may be optically clear and laser-resistant. The first partition and the second partition may be sapphire glass or transparent spinel ceramics.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of an improved system for three-dimensional printing by selective sintering;

FIG. 2 is a perspective view of a tank of the system of FIG. 1;

FIG. 3 is a cross-sectional view of the tank of FIG. 2;

FIG. 4 is a perspective view of the system of FIG. 1 showing sliding partitions thereof at an innermost position;

FIG. 5 is a perspective view of the system of FIG. 1 showing sliding partitions thereof at an intermediate position;

FIG. 6 is a perspective view of the system of FIG. 1 showing sliding partitions thereof at an outermost position;

FIG. 7 is a fragmentary view showing the sliding partitions of the system of FIG. 1;

FIG. 8 is a perspective view of a sliding partition of the system of FIG. 1;

FIG. 9A is a side view of another embodiment of sliding partitions which may be used with the system of FIG. 1;

FIG. 9B is a perspective view of one of the sliding partitions of FIG. 9A;

FIG. 10A is a side view of still another embodiment of sliding partitions which may be used with the system of FIG. 1;

FIG. 10B is a perspective view of one of the sliding partitions of FIG. 10A;

FIG. 11 is a perspective view of the system of FIG. 1 showing an article being formed as both of the sliding partitions move step-wise;

FIG. 12 is a perspective view of the system of FIG. 1 showing an article being formed as one of the sliding partitions moves step-wise; and

FIG. 13 is a perspective view of another improved system for three-dimensional printing by selective sintering.

### DESCRIPTIONS OF THE PREFERRED EMBODIMENTS

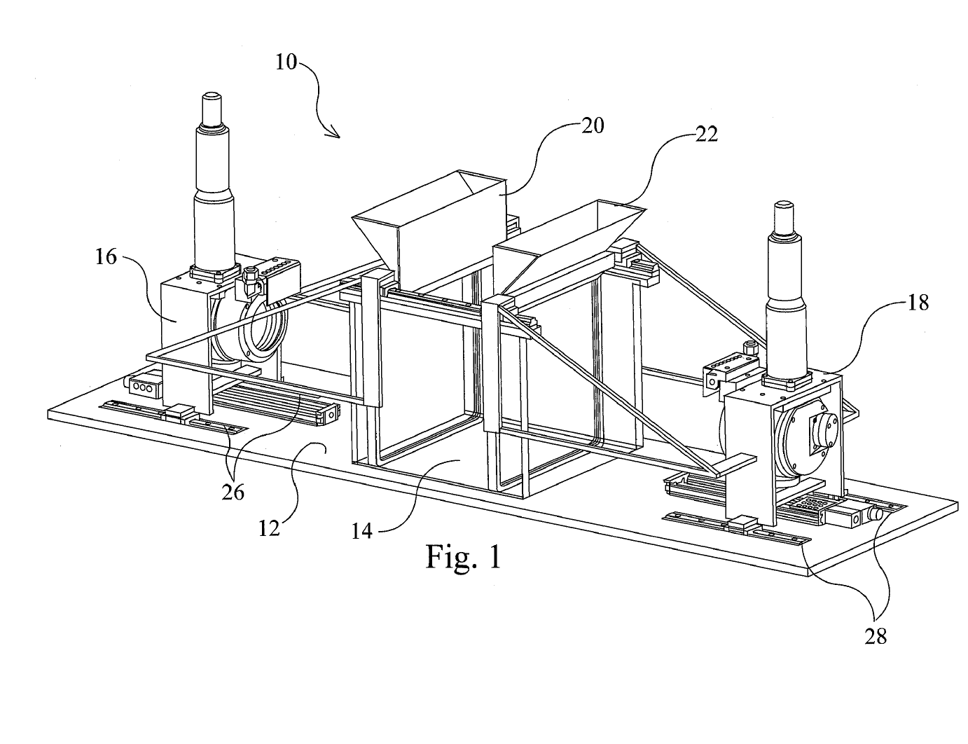

Referring to the drawings and first to FIG. 1, there is shown a system 10 for three-dimensional printing by selective sintering. The system 10 generally comprises a platform 12 that supports a tank 14, a first laser 16, and a second laser 18. There are also material dispensers in the form of hoppers 20 and 22 in communication with the tank 14. The tank 14 is maintained in a fixed position on the platform 12 while the first laser 16 and the second laser 18 are each mounted on respective linear guides 26 and 28 to allow movement of the lasers relative to the tank 14. In this example, the lasers are YAG lasers but any suitable lasers may be used.

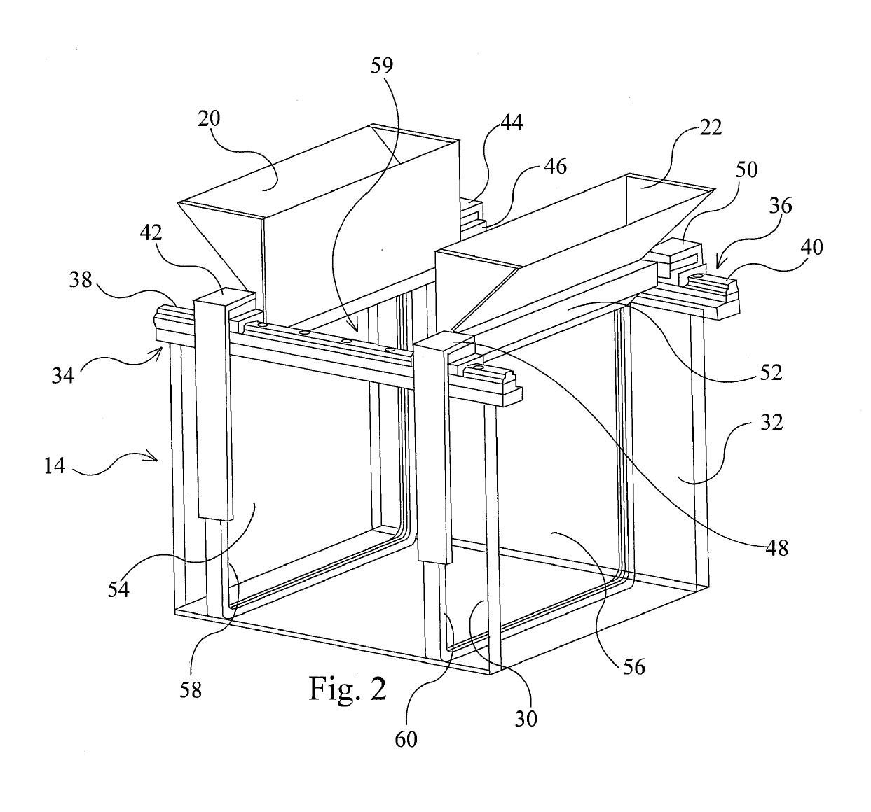

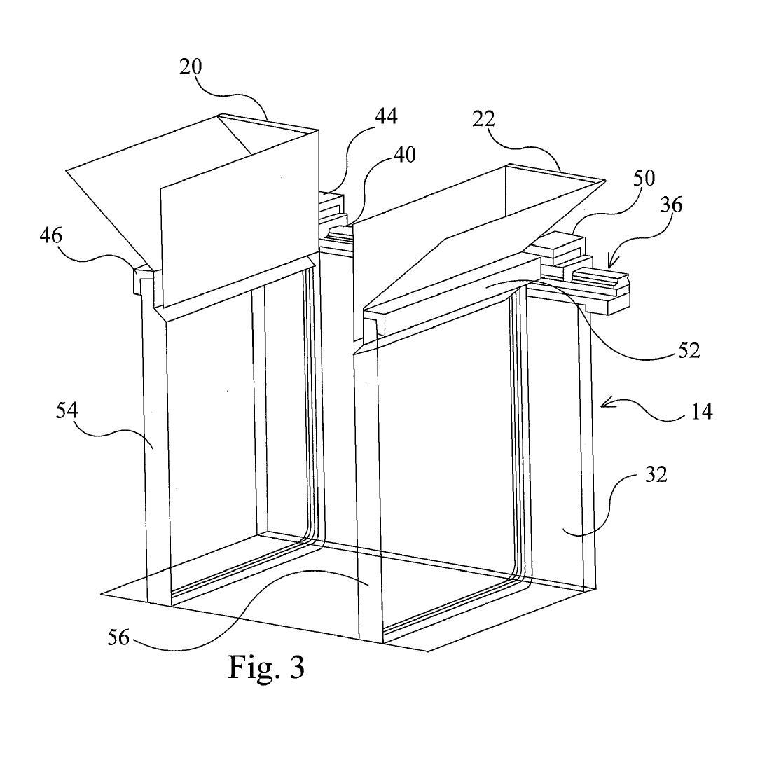

The tank 14, which is shown in greater detail in FIGS. 2 and 3, includes opposed side walls 30 and 32 which are releasably connected to the platform 12. There are linear guides 34 and 36 which are each mounted on corresponding ones of the side walls 30 and 32. The linear guides 34 and 36 each include a respective one of sliding tracks 38 and 40. Respective first sliding blocks 42 and 44 of the linear guides 34 and 36 are coupled by a first linking arm 46. Likewise, respective second sliding blocks 48 and 50 of the linear guides 34 and 36 are coupled by a second linking arm 52. A first partition 54 hangs from the first linking arm 46 and a second partition 56 hangs from the second linking arm 52. The first partition 54 and the second partition 56 are translucent panels that are each provided with a respective one of peripheral seals 58 and 60 which respectively seal the first partition 54 and the second partition 56 against the side walls 30 and 32 of the tank 14. The partitions are optically clear and laser-resistant in this example and may be formed of sapphire glass or transparent spinel ceramics. Accordingly, the first partition 54 and the second partition 56 define a partially sealed central chamber 59 of the tank 14. The hoppers 20 and 22 are in communication with the central chamber 59 of the tank 14.

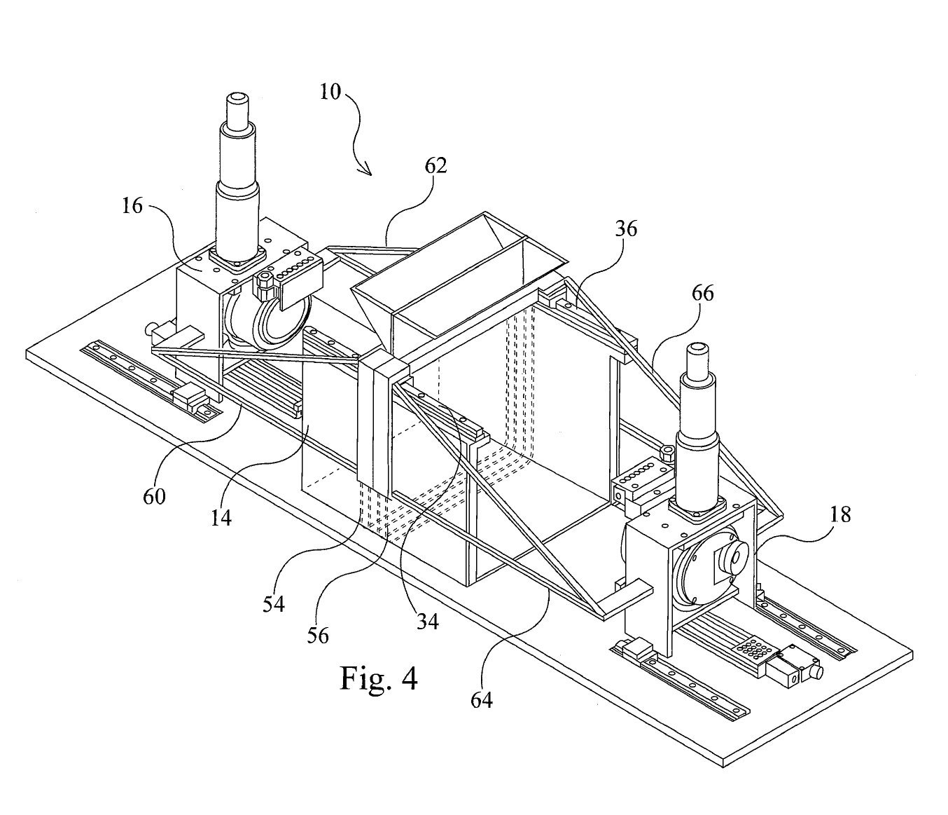

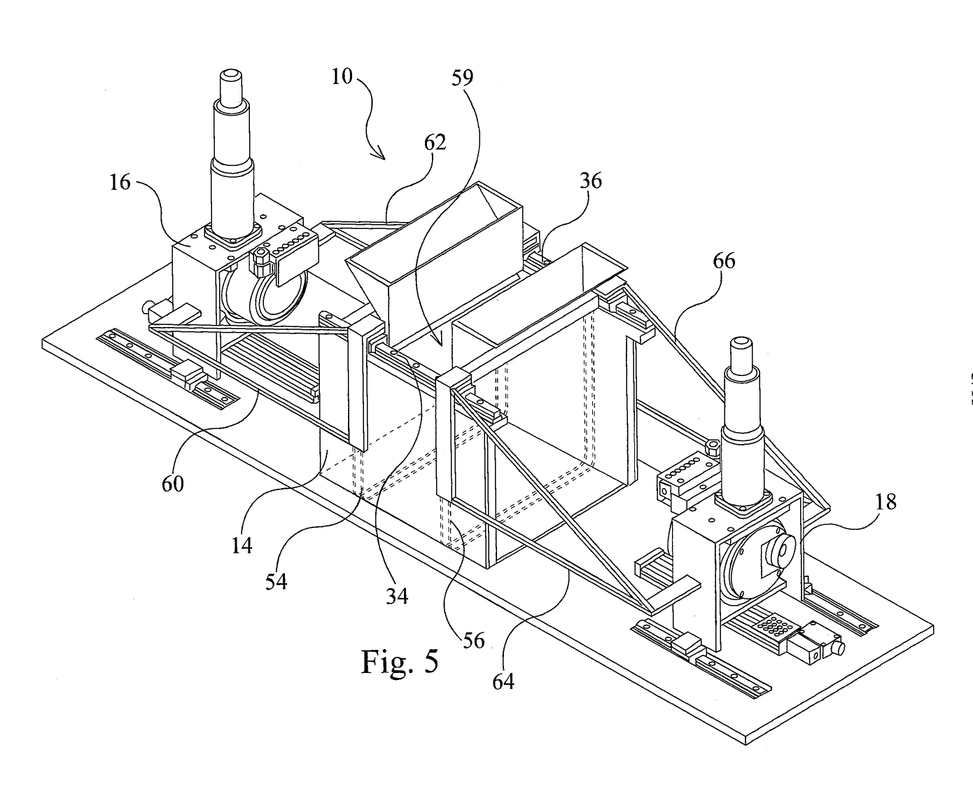

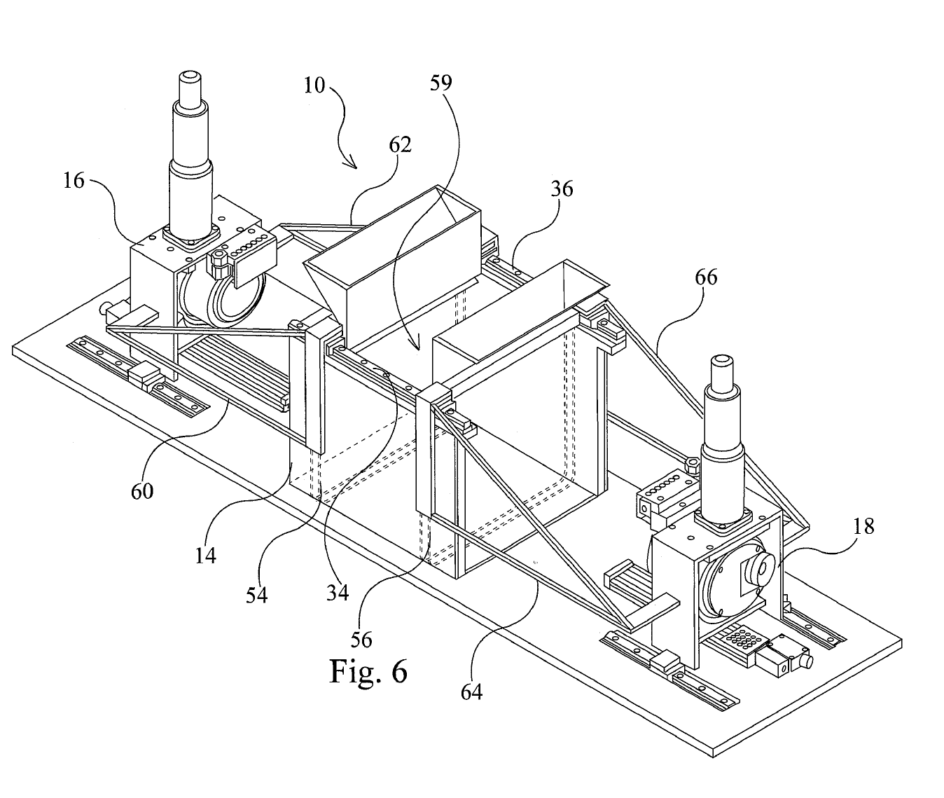

Referring now to FIGS. 4 to 6, the first partition 54 and the second partition 56 are independently slidable, or moveable, along the linear guides 34 and 36. Linking arms 60 and 62 couple the first partition 54 to the first laser 16 resulting in the first partition 54 moving step-wise with the first laser 16. Linking arms 64 and 66 couple the second partition 56 to the second laser 18 resulting in the second partition 56 moving step-wise with the second laser 18. Movement of the first partition 54 and the second partition 56 allows the central chamber 59 of the tank 14 to be dynamically and selectively changed. FIG. 4 shows the first partition 54 and the second partition 56 at innermost positions within the tank 14. FIG. 5 shows the first partition 54 and the second partition 56 at intermediate positions within the tank 14. FIG. 6 shows the first partition 54 and the second partition 56 at outermost positions within the tank 14. It will be understood by a person skilled in the art that the first partition 54 and the second partition 56 may be selectively moved between their innermost positions, shown in FIG. 4, and their outermost positions shown in FIG. 6.

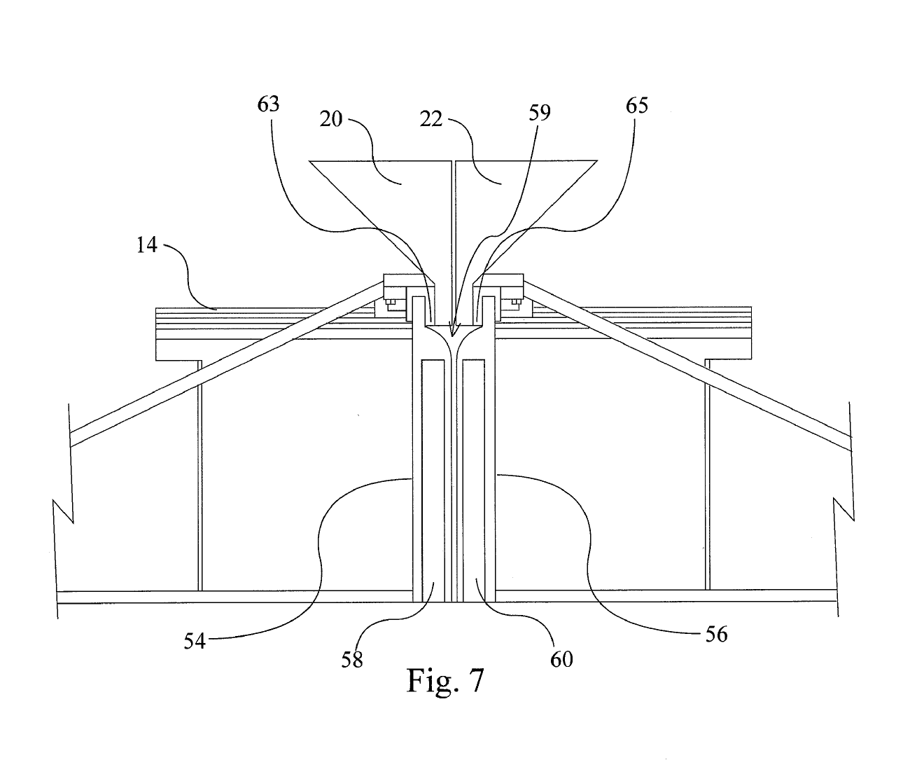

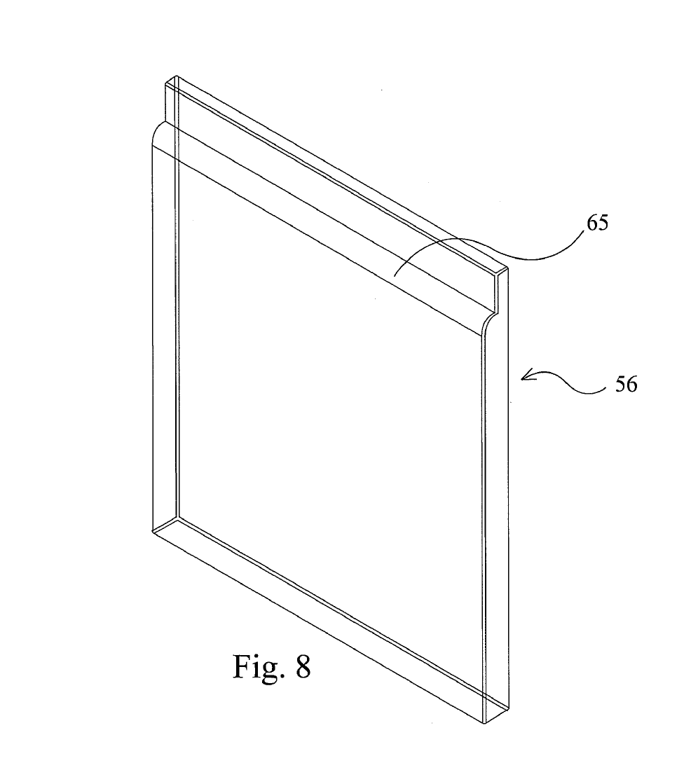

In operation, the first partition 54 and the second partition 56 are moved to their innermost positions at which point the first partition 54 and the second partition 56 are approximately 10 to 20 microns apart in this example. The central chamber 59 of the tank 14 is filled with the material to a desired level just below respective fillets 63 and 65 of the first partition 54 and the second partition 56 which are best shown in FIG. 7. The fillets 63 and 65 may function to ensure uniform or even distribution of the material dispensed from the hoppers 20 and 22 into the central chamber 59 of the tank 14. The material may be, for example, a ceramic or a metal and may be in particulate form including powder. FIG. 8 shows the fillet 65 of the second partition 56 in greater detail.

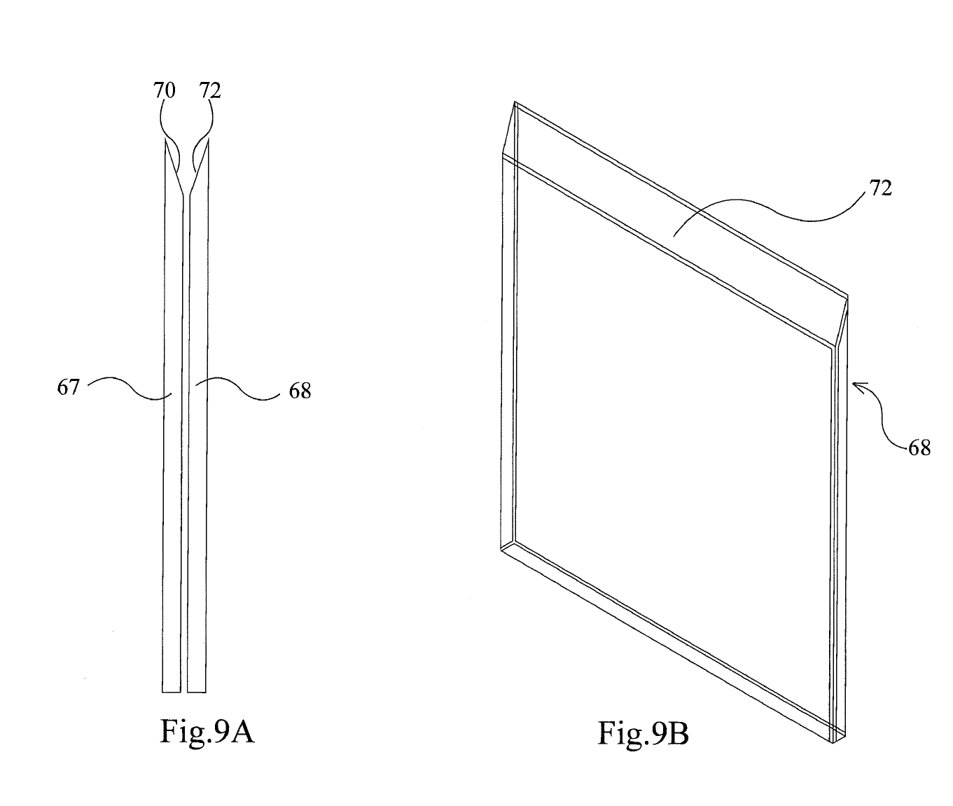

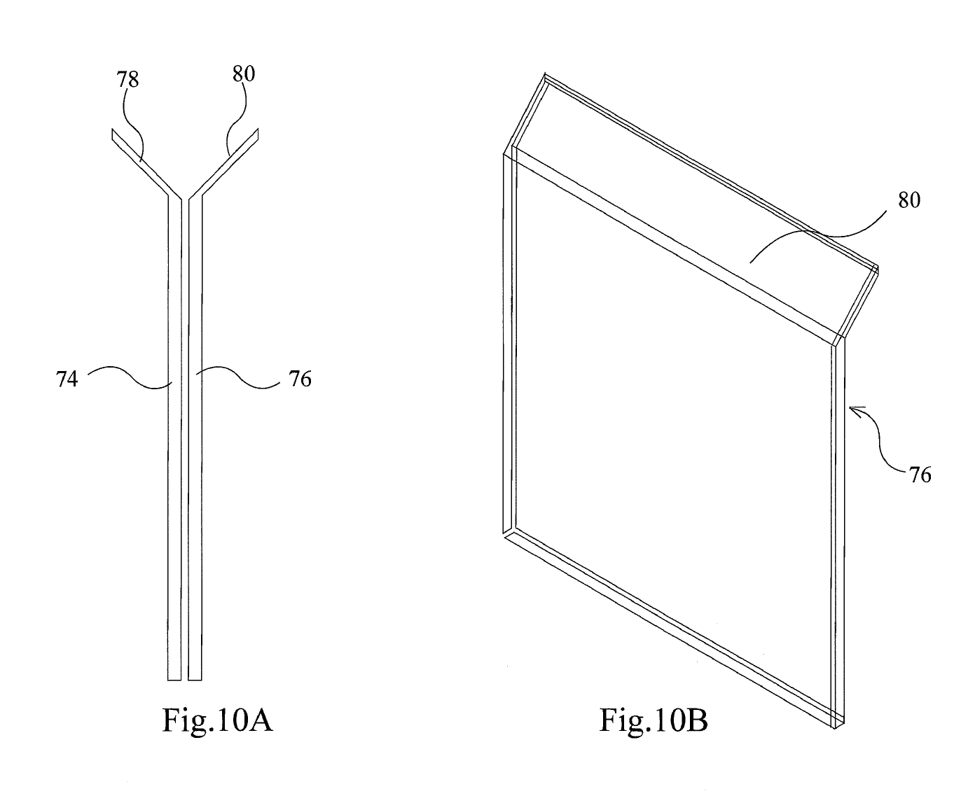

It may also be possible to use other geometries to achieve uniform or even distribution of the material. FIGS. 9A and 9B show a first partition 67 and a second partition 68, each provided with a respective bevel 70 and 72. FIGS. 10A and 10B show a first partition 74 and a second partition 76 each provided with a respective angularly extending flange 78 and 80. The partitions may be formed of sapphire glass or transparent spinel ceramics.

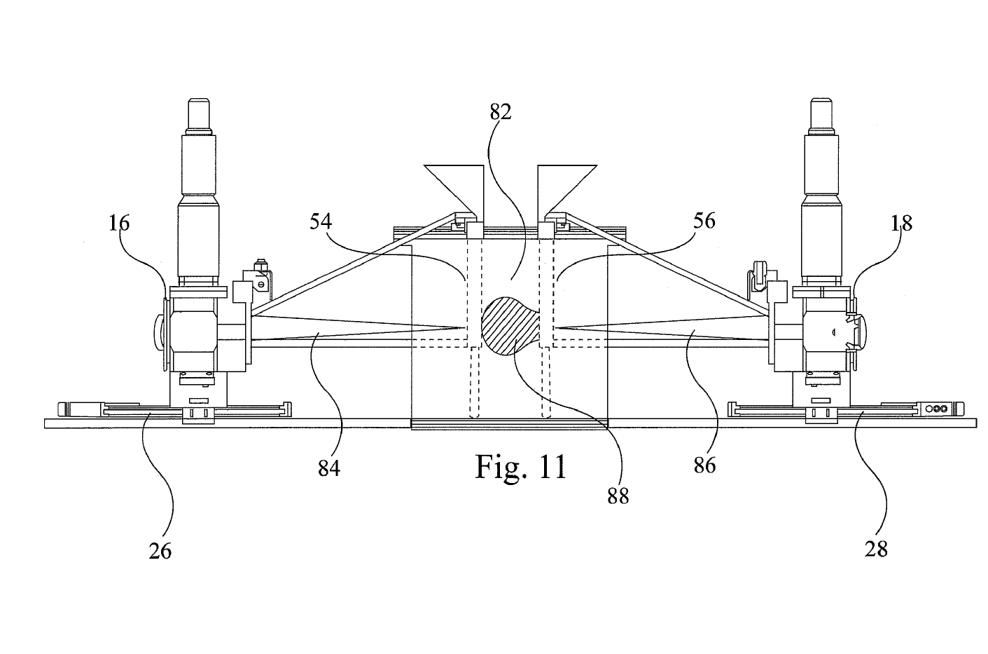

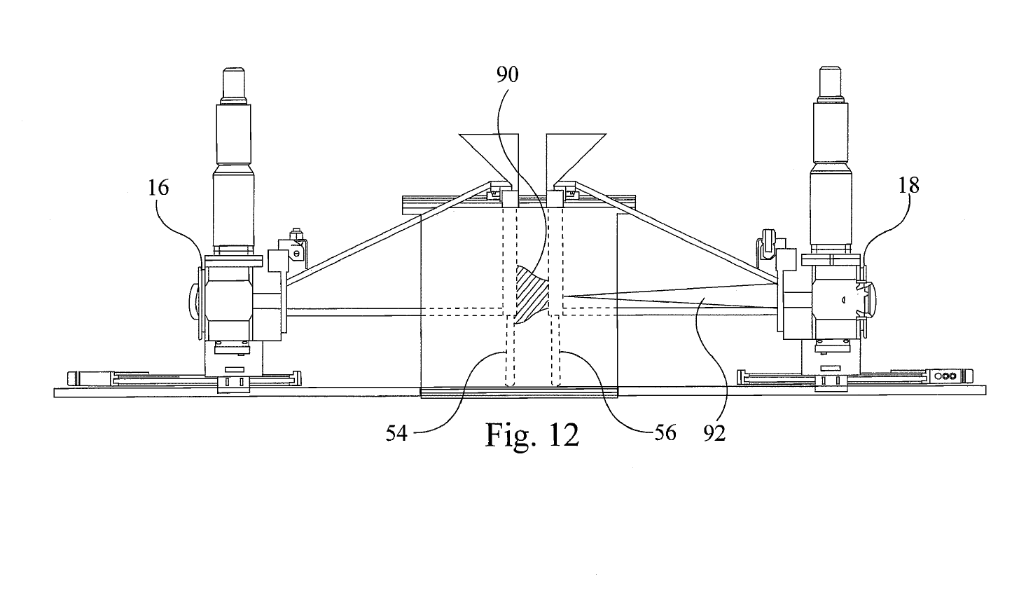

Referring now to FIG. 11, the level of material 82 will generally remain constant throughout operation of the system. The first laser 16 and the second laser 18 then emit respective laser beams 84 and 86 which cause the formation of adjacent inner cross-sections of an article 88 being formed. Following the formation of the adjacent inner cross-sections, the first partition 54 and the second partition 56 are moved step-wise from their innermost position towards their outermost position. A laser beam is emitted by the first laser 16 and the second laser 18 following each step-wise movement of the first partition 54 and the second partition 56. Each laser beam causes the formation of a cross-section of the article 88 being formed. The article is accordingly formed step-wise in an outwardly direction. The first laser 16 and the second laser 18 move step-wise along their respective linear guides 26 and 28 and in tandem with the first partition 54 and the second partition 56 to maintain a constant focus distance. In FIG. 12, the first partition 54 remains stationary as the second partition 56 and the laser 18 move step-wise as an article 90 is being formed as a result of a laser beam 92 emitted by the second laser 18.

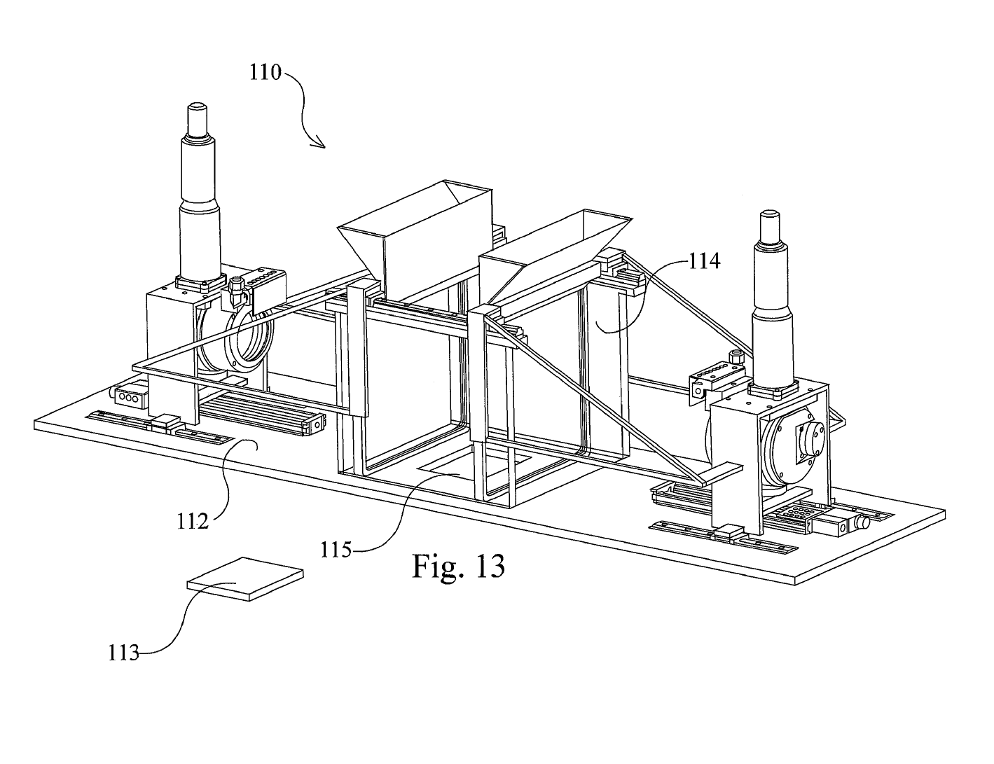

Another embodiment of a system 110 for three-dimensional printing by selective sintering is shown in FIG. 13. The system 110 shown in FIG. 13 is generally similar to the system 10 shown in FIG. 1 with the exception that a platform 112 is provided with a removable portion 113 in the center of a tank 114. The removable portion 113 is removed to allow material to be removed from the tank through an opening 115.

The systems of FIGS. 1 to 13 show the tank and the lasers in horizontal alignment. However, in alternative embodiments of the system, the tank and the lasers may be in vertical alignment in a double elevator system. The systems shown in FIGS. 1 to 13 have two lasers. However, in alternative embodiments of the system, a single laser may be used with a laser beam splitter such as a mirror to split the laser beam to form at least two sections of the object being formed.

It will be understood by a person skilled in the art that many of the details provided above are by way of example only, and are not intended to limit the scope of the invention which is to be determined with reference to the following claims.

1. A selective sintering system comprising:
a first laser;
a second laser;
a tank disposed between the first laser and the second laser, the tank including a first moveable partition and a second moveable partition which define a central chamber of the tank; and
a dispenser in communication with and providing material to be sintered to the central chamber of the tank.

2. The selective sintering system as claimed in claim 1 wherein the first moveable partition and the second moveable partition are each moveable step-wise from innermost positions to outermost positions.

3. The selective sintering system as claimed in claim 1 or 2 wherein the first moveable partition is moveable step-wise in tandem with the first laser and the second moveable partition is moveable step-wise in tandem with the second laser.

4. The selective sintering system as claimed in claim 1 wherein the first moveable partition and the second moveable partition are each provided with a fillet.

5. The selective sintering system as claimed in claim 1 wherein the first moveable partition and the second moveable partition are each provided with an angular extending flange.

6. The selective sintering system as claimed in claim 1 wherein the first moveable partition and the second moveable partition are each provided with a bevel.

7. The selective sintering system as claimed in claim 1 wherein the first partition and the second partition are optically clear and laser-resistant.

8. The selective sintering system as claimed in claim 1 wherein the first partition and the second partition are sapphire glass.

9. The selective sintering system as claimed in claim 1 wherein the first partition and the second partition are transparent spinel ceramics.

10. The selective sintering system as claimed in claim 1 wherein the first laser, the second laser, and the tank are generally aligned horizontally.

11. The selective sintering system as claimed in claim 1 wherein the first laser, the second laser, and the tank are generally aligned vertically.

12. A selective sintering system comprising:
a moveable laser;
a tank including a first partition and a second partition which define a central chamber of the tank, the second partition being moveable; and
a dispenser in communication with and providing material to be sintered to the central chamber of the tank, wherein a cross-section of an article is formed on an inner side of the first partition as the moveable laser moves step-wise with the second moveable partition then emits a beam.

13. The selective sintering system as claimed in claim 12 wherein the moveable laser moves step-wise in tandem with the second moveable partition.
